(19) United States
(12) Patent Application Publication
(10) Pub. No.: US 2003/0001752 A1
(43) Pub. Date: Jan. 2, 2003

(54) Apparatus for extending lifetime of garage door opener lights

(76) Inventor: Leonides Y. Teves, Bradenton, FL (US)

Correspondence Address: SMITH & HOPEN PA, 15950 BAY VISTA DRIVE, SUITE 220, CLEARWATER, FL, 33760

(21) Appl. No.: 09/681,923

(22) Filed: Jun. 27, 2001

(51) Int. Cl. G08B 23/00

(52) U.S. Cl. 340/693.9; 340/691.1; 340/825.72

(57) ABSTRACT

7A garage door opener is adapted to activate an illumination source such as a light bulb that is mounted in a location within a garage that is sufficiently remote from the garage door opener so as to be substantially unaffected by vibrations generated by the operation of the garage door opener. In a preferred embodiment, an electrical socket is formed in a housing of the garage door opener and a plug is adapted to releasably engage the electrical socket. The plug is in electrical communication with the remotely mounted illumination source. When a consumer activates the garage door opener, the opener generates a signal that causes electrical power to be delivered to the electrical socket. A timer sends a second signal to disconnect the electrical power after the lapse of a predetermined time. This construction substantially lengthens the lifetime of the illumination source.

### BACKGROUND OF INVENTION

1Field of the Invention

This invention relates, generally, to garage door openers. More particularly, it relates to a garage door opener of the type that provides illumination when a garage door opener opens a garage door.

2. Description of the Prior Art

Most garage door openers are equipped with lights that are illuminated when the opener opens a garage door. Specifically, the lights are typically mounted on the exterior surface of the main housing of the garage door opener. The housing houses the motor that provides the mechanical power to raise and lower the garage door, as well as associated parts of the opener apparatus such as limit switches and the like.

As every user of garage door openers knows, such light bulbs do not last long. Consequently, if the user desires to have an illuminated garage when the door is opened, three or four trips up a stepladder to change light bulbs are required each year. Most people eventually realize that the vibration of the motor causes breakage of the filaments. They then stop replacing conventional light bulbs and start purchasing expensive light bulbs designed especially to withstand the effects of vibration. This reduces the number of bulb changing operations required per year, but does not entirely solve the problem.

What is needed, then, is a permanent solution to the problem of short-lived light bulbs of garage door openers.

However, in view of the prior art considered as a whole at the time the present invention was made, it was not obvious to those of ordinary skill in the pertinent art how the identified problem could be overcome.

### SUMMARY OF INVENTION

The longstanding but heretofore unfulfilled need for a garage door opener having an extended life illumination means is now met by a new, useful, and nonobvious apparatus having an illumination means mounted on a substantially vibration-free mounting surface within a garage. An electrical conductor is disposed in electrical communication between the garage door opener and the illumination means.

The garage door opener includes an electrical socket means built into the housing of the garage door opener. A first end of the electrical conductor is conductively connected to the garage door opener electrical socket means. A second end of the electrical conductor is conductively connected to the illumination means.

The garage door opener is adapted to bring the garage door opener electrical socket means into electrical communication with line current when a user activates the garage door opener in a well-known way. The garage door opener is further adapted to electrically disconnect the garage door opener electrical socket means from the line current a predetermined amount of time after the activation of the garage door opener.

A primary object of the invention is to provide an apparatus for extending the lifetime of an illumination means of the type activated and deactivated by a garage door opener.

A closely related object is to attain the foregoing object with a device that does not require a homeowner to purchase special vibration-resistant light bulbs.

A more specific object is to provide an apparatus that interconnects a garage door opener to a remotely mounted illumination means so that vibrations generated by the garage door opener are substantially attenuated before they reach the illumination means.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF DRAWINGS

For a fuller understanding of the nature and objects of the invention, reference should be made to the following detailed description, taken in connection with the accompanying drawings, in which:

FIG. 1 is a side elevational view of an illustrative embodiment of this invention; and

FIG. 2 is an enlarged perspective view of a preferred electrical connector that forms a part of the illustrative embodiment.

### DETAILED DESCRIPTION

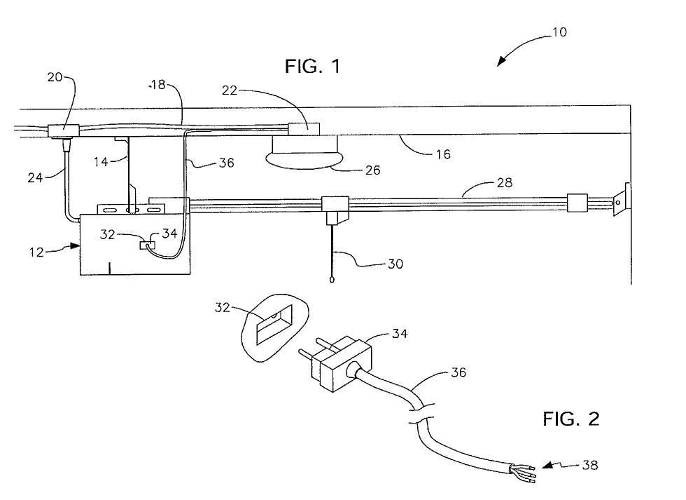

Referring now to FIG. 1, it will there be seen that the reference numeral 10 denotes an illustrative embodiment of the present invention as a whole.

Housing 12 houses a motor, limit switches, means connected to the output shaft of the motor for engaging a chain or a screw, means for receiving an ultra high frequency radio signal, and other well-known components, none of which are depicted.

Bracket means 14 secures housing 12 to ceiling 16 of a garage. Electrical conduit 18 is positioned out-of-sight in a well-known way above ceiling 16. It delivers power to junction boxes 20 and 22. Electrical conduit 24 provides electrical communication between junction box 20 and the power-requiring elements housed within housing 12. Conventional lighting fixture 26 is mounted to ceiling 16 in a well-known way and the illumination means housed therewithin is electrically coupled to conduit 18 at junction box 22.

Elongate horizontal rail 28 and pull cord 30 form no part of the invention per se. Such elements are part of a conventional garage door opener and are depicted just to indicate the environment of the invention. The same comment also applies to the remaining unnumbered parts of the depicted garage door opening system.

It should be observed that housing 12, unlike conventional garage door openers, includes no sockets for screw-threadingly receiving light bulbs and therefore no translucent cover for covering light bulbs. This lowers the cost of manufacturing the novel garage door opener and thus lowers the cost to consumers.

Instead of such light bulb-receiving sockets, housing 12 includes an electrical socket 32 of the type adapted to releasably engage an electrical plug. As perhaps best understood in connection with FIG. 2, electrical socket 32 is adapted to releasably engage plug means 34.

Plug means 34 is in electrical communication with elongate, insulated electrical cord 36 that provides electrical communication between plug 34 and junction box 22 in the manner depicted in FIG. 1. Uninsulated wires 38 at the distal end of cord 36 are in electrical communication injunction box 22 with unillustrated wires that extend to said junction box 22 from electrical contacts of the illumination means housed within lighting fixture 26. The use of junction boxes is not essential to this invention.

Plug means 34 provides a convenient way to electrically interconnect socket 32 and the illumination means housed within light fixture 26. However, numerous other electrical connection devices are well known to those of ordinary skill in the electrical arts and all of such substitute electrical connection devices are within the scope of this invention.

For example, most consumers are familiar with spring-loaded jacks that are positioned at the rear of audio speakers. A pair of opposed flat flap members is manually squeezed, an uninsulated length of wire is inserted into a space created in the jack by such squeezing action, and the flat flap members are released. A bias means returns to its position of repose when the flat members are released, and the uninsulated length of wire is held in electrical communication with an electrical contact in the jack by the force provided by the bias means.

In another well-known commercially available embodiment, a jack includes an electrical contact and a screw that is adjustable relative thereto. An uninsulated length of wire is wrapped around the post of the screw when the screw head is backed away from the electrical contact, and the screw is then advanced until the screw head tightly holds said uninsulated length of wire to the contact.

Plug means 34 is preferred because it does not require a consumer to squeeze together an opposing set of flaps, does not require a screwdriver, and is the most well known form of electrical connector.

Light fixture 26 and the illumination means housed therewithin may be provided as a part of a garage door opener kit by the manufacturer of the garage door opener, or said fixture may be a pre-existing fixture mounted on ceiling 16 of the garage. Either way, the light bulb or bulbs housed within light fixture 26 are activated and deactivated by signals from the garage door opener in a well-known way when a user activates the garage door opener. Such signals in a conventional garage door opener are communicated to the electrical sockets mounted on housing 12 within which are mounted incandescent light bulbs. As is well known, a first signal activates the light bulbs when the garage door opener is activated and a second signal deactivates said light bulbs, usually about four minutes after activation.

Light fixture 22, whether as a pre-existing part of the garage or as a part of a garage door opener kit, is securely mounted on garage door ceiling 16 as mentioned earlier. Accordingly, vibrations generated by the garage door opener during its operation do not affect the incandescent or fluorescent illumination means in fixture 26.

Light fixture 26 need not be mounted on garage ceiling 16. It may be mounted on a wall or any other suitable mounting means within the garage other than the housing of the garage door opener. Such other suitable mounting means includes any mounting surface not subjected to vibrations emanating from the garage door opener.

This is the first disclosure, anywhere in the world, of a garage door opener that activates a remote light, unaffected by vibrations generated by the garage door opener, when the garage door opener is activated. Accordingly, the claims that follow are entitled to broad interpretation to protect the heart of essence of the invention.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

1. An apparatus for extending the operating life of an illumination means of the type activated and deactivated by a garage door opener, comprising:
an illumination means mounted on a substantially vibration-free mounting surface within a garage;
an electrical conductor disposed in electrical communication between said garage door opener and said illumination means;
said garage door opener including an electrical socket means;
a first end of said electrical conductor being conductively connected to said garage door opener electrical socket means and a second end of said electrical conductor being conductively connected to said illumination means;
said garage door opener adapted to bring said garage door opener electrical socket means into electrical communication with line current when said garage door is activated by a user; and
said garage door opener adapted to electrically disconnect said garage door opener electrical socket means from said line current a predetermined amount of time after said activation of said garage door opener.

2. The apparatus of claim 1, wherein said vibration-free mounting surface is a ceiling of said garage.

3. The apparatus of claim 1, wherein said illumination means is housed within a light fixture.

4. The apparatus of claim 1, wherein said illumination means is at least one incandescent light bulb.

5. The apparatus of claim 1, wherein said illumination means is at least one fluorescent light bulb.
